(19) United States
(12) Patent Application Publication
(10) Pub. No.: US 2010/0308013 A1
(43) Pub. Date: Dec. 9, 2010

(54) DISPLAY DEVICE AND METHOD FOR MANUFACTURING THE SAME

(76) Inventor: Kenji MIYAMOTO, Nara (JP)

Correspondence Address: BIRCH STEWART KOLASCH & BIRCH, PO BOX 747, FALLS CHURCH, VA, 22040-0747, US

(21) Appl. No.: 12/845,344

(22) Filed: Jul. 28, 2010

Related U.S. Application Data
(62) Division of application No. 11/406,241, filed on Apr. 19, 2006.

(30) Foreign Application Priority Data
Apr. 26, 2005 (JP) 2005-128664

(51) Int. Cl. B32B 38/10

(52) U.S. Cl. 216/24

(57) ABSTRACT

A liquid crystal display device includes: an active matrix substrate including a glass substrate; a counter substrate which is arranged to face the active matrix substrate and includes a glass substrate which is thinner than the glass substrate of the active matrix substrate; and a display medium layer which is provided between the active matrix substrate and the counter substrate. The rate at which the glass substrate of the active matrix substrate is etched by an etching solution is lower than the rate at which the glass substrate of the counter substrate is etched by the etching solution.

### CROSS-REFERENCE TO RELATED APPLICATION

This application is a Divisional of co-pending application Ser. No. 11/406,241 filed on Apr. 19, 2006, which claims priority to Application No. 2005-128664 filed in JP, on Apr. 26, 2005. The entire contents of all of the above applications is hereby incorporated by reference.

### BACKGROUND OF THE INVENTION

1. Field of the Invention

The present invention relates to a display device including a display medium layer provided between a pair of substrates and a method for manufacturing the same.

2. Description of Related Art

In recent years, there has been a growing demand for mobile devices such as cellular phones and digital video cameras. The mobile devices are provided with display devices such as liquid crystal display panels. These liquid crystal display devices are relatively medium or small in size. For example, as shown in FIG. 9, a liquid crystal display panel 100 includes a pair of glass substrates 101 and 102 and a liquid crystal layer 103 sealed between the substrates.

In particular when the final size of a device is required to be small, the slimming down of the liquid crystal display panel 100 as one of the components thereof is a very important issue. Specifically, the liquid crystal display panel 100 is a relatively large component among the components of a mobile device. Therefore, even though the other components are downsized, dramatic size reduction of the device cannot be expected unless the size of the liquid crystal display panel 100 is reduced. However, the liquid crystal display panel 100 is required to keep a certain display area in terms of viewability. Therefore, reduction in thickness is required in order to downsize the liquid crystal display panel 100.

According to a known method, the glass substrates 101 and 102 of the liquid crystal display panel 100 are thinned down by etching (e.g., see Japanese Unexamined Patent Publication No. H4-116619). Specifically, a pair of glass substrates bonded to each other are immersed in an etching solution such as hydrogen fluoride for a certain period of time which is determined in accordance with the final thickness of the substrates, thereby thinning down the glass substrates 101 and 102 of the liquid crystal display panel 100.

As a typical example, a substrate assembly of 2.2 to 1.4 mm in total thickness prepared by bonding a pair of glass substrates each having an initial thickness of 1.1 to 0.7 mm is thinned down to have a total thickness of 1.0 mm (the thicknesses a and b of the glass substrates are reduced to 0.5 mm, respectively).

In recent years, however, the substrate assembly is required to have a total thickness as small as 0.8 or 0.6 mm. A 0.8 mm thick substrate assembly can be achieved by the above-described conventional method. However, in order to obtain a 0.6 mm thick substrate assembly, the thicknesses a and b of the bonded glass substrates 101 and 102 shown in FIG. 9 must be 0.3 mm, respectively. As a result, the strength of the glass substrates 101 and 102 decreases, thereby inevitably impairing the reliability of the liquid crystal display device (resistance against vibration and drop).

If the thicknesses a and b of the glass substrates 101 and 102 are reduced to as small as about 0.3 mm, it would be difficult to handle the glass substrates 101 and 102 during the manufacture of the liquid crystal display device and problems may arise in terms of cost and yield.

Therefore, in order to slim down the liquid crystal display panel while ensuring the strength of the glass substrates, one of the two glass substrates which requires relatively high strength is made thick and the other glass substrate which does not require relatively high strength is made thin (e.g., see Japanese Unexamined Patent Publications Nos. H5-249422 and H5-249423).

Specifically, referring to FIG. 9, a glass substrate 101 serving as a TFT substrate on which a plurality of thin-film transistors (hereinafter referred to as TFTs) will be formed and to which a flexible substrate 104 will be bonded is made relatively thick to have a thickness a of about 0.4 mm. Then, another glass substrate 102 serving as a counter substrate facing the TFT substrate is made relatively thin to have a thickness b of about 0.2 mm. The flexible substrate 104 is provided with a driver IC 105 for driving the TFTs.

In reality, however, it is still difficult to handle the thin glass substrates in a usual manufacture line in terms of strength. Each of the glass substrates preferably has a thickness of 0.7 mm or more in the early stage of the manufacture before the glass substrates are subjected to etching.

In order to obtain the above-described substrate assembly having a total thickness of about 0.6 mm by making one of the glass substrates thick, the thickness of one of the two 0.7 mm thick glass substrates needs to be reduced by 0.3 mm to 0.4 mm, while that of the other glass substrate needs to be reduced by 0.5 mm to 0.2 mm.

Therefore, according to a first method as disclosed by Japanese Unexamined Patent Publication No. H5-249422, the substrate assembly is immersed in an etching solution for a certain period of time with one of the glass substrates covered with a resist mask, thereby etching only one of the glass substrates. Then, the resist mask is removed and the substrate assembly is immersed again in the etching solution to etch both of the glass substrates. As a result, the etch amounts of the glass substrates are varied, thereby achieving the above-described structure.

According to a second method, the substrate assembly is immersed in the etching solution to etch both of the glass substrates to 0.4 mm. Then, only one of the glass substrates is subjected to mechanical polish such as blasting so that the thickness is reduced to 0.2 mm. Also in this method, the above-described structure is achieved.

In the first method, however, four steps including a resist mask formation step, a first etching step, a resist mask removal step and a second etching step are additionally required. Further, in the second method, two steps including an etching step and a mechanical polish step are added. That is, both of the methods require several additional steps, whereby problems may arise in terms of production cost and yield.

### SUMMARY OF THE INVENTION

In light of the above-described problems, the present invention has been achieved. An object of the present invention is to slim down the display device through simple manufacturing steps with reduction in production cost and improvement in yield.

In order to achieve the object, in the present invention, the etch rate of a glass substrate of a first substrate is set lower than the etch rate of a glass substrate of a second substrate.

Specifically, a display device of the present invention includes: a first substrate including a glass substrate; a second substrate which is arranged to face the first substrate and includes a glass substrate which is thinner than the glass substrate of the first substrate; and a display medium layer which is provided between the first substrate and the second substrate, wherein the rate at which the glass substrate of the first substrate is etched by an etching solution is lower than the rate at which the glass substrate of the second substrate is etched by the etching solution.

The glass substrate of the first substrate preferably has higher mechanical strength than that of the glass substrate of the second substrate.

A flexible printed substrate may be mounted on the first substrate.

It is preferable that the first substrate is an active matrix substrate on which a plurality of thin-film transistors and a driver for driving the thin-film transistors are formed and the driver includes an element which is made of low-temperature polysilicon.

It is preferable that the first substrate is an active matrix substrate on which a plurality of thin film transistors and a driver for driving the thin-film transistors are formed and the driver includes an element which is made of CG silicon.

A display device of the present invention includes a glass substrate; a plastic substrate which is arranged to face the glass substrate and thinner than the glass substrate; and a display medium layer which is provided between the glass substrate and the plastic substrate.

A method for manufacturing a display device according to the present invention is a method for manufacturing a display device comprising a first substrate including a glass substrate, a second substrate which is arranged to face the first substrate and includes a glass substrate which is thinner than the glass substrate of the first substrate and a display medium layer which is provided between the first substrate and the second substrate, the method comprising the steps of: bonding the glass substrate of the first substrate and the glass substrate of the second substrate to each other and providing the display medium layer between the bonded glass substrates; and immersing the bonded glass substrates in an etching solution such that each of the glass substrates is thinned down.

The glass substrate of the first substrate and the glass substrate of the second substrate preferably have the same thickness before etching.

The glass substrate of the first substrate preferably has higher mechanical strength than that of the glass substrate of the second substrate.

The method may further include the step of mounting a flexible printed substrate on the first substrate including the etched glass substrate.

The method preferably includes the step of forming a plurality of thin-film transistors including elements made of low-temperature polysilicon and a driver which drives the thin-film transistors and includes an element made of low temperature polysilicon on the glass substrate of the first substrate before etching the glass substrate of the first substrate.

The method may include the step of forming a plurality of thin-film transistors including elements made of CG silicon and a driver which drives the thin-film transistors and includes an element made of CG silicon on the glass substrate of the first substrate before etching the glass substrate of the first substrate.

The method preferably includes the steps of bonding a glass substrate and a plastic substrate and forming a display medium layer between the glass substrate and the plastic substrate; and immersing the glass substrate and the plastic substrate bonded to each other in an etching solution such that only the glass substrate is thinned down.

The etched glass substrate is preferably thicker than the plastic substrate.

A method for manufacturing a display device according to the present invention includes the steps of: bonding a first substrate including a glass substrate and a second substrate including a glass substrate to each other and forming a display medium layer between the first substrate and the second substrate, the glass substrate of the second substrate having a thickness different from that of the glass substrate of the first substrate and being etched by an etching solution at the same rate as the glass substrate of the first substrate; and immersing the first substrate and the second substrate bonded to each other in an etching solution such that each of the glass substrates is thinned down.

The display medium layer is preferably a liquid crystal layer.

Now, an explanation of the effect of the present invention will be provided.

A first substrate and a second substrate as components of a display device include glass substrates, respectively. If the etch rates of the glass substrates in an etching solution are varied, the glass substrates are etched by different thicknesses even if they are immersed in the etching solution for the same period of time. Therefore, if the glass substrates have the same thickness before they are subjected to etching, the total thickness of the first and second substrates is reduced and the glass substrates are varied in thickness after the etching. The glass substrates preferably have the same thickness before etching such that the glass substrates are easily handled in the manufacture line.

When a flexible printed substrate is press-mounted on the substrate, the substrate needs to have certain mechanical strength. Therefore, the glass substrate of the first substrate is made thicker than the glass substrate of the second substrate such that the glass substrate of the first substrate has higher mechanical strength than the glass substrate of the second substrate. Specifically, the total thickness of the first and second substrates is reduced while ensuring the strength of the first substrate, thereby permitting the flexible printed substrate to be mounted on the first substrate.

On the first substrate, a driver including an element made of low-temperature polysilicon or CG silicon is formed. Therefore, the thickness of the display device is further reduced.

If a glass substrate and a plastic substrate are used as a pair of substrates, only the glass substrate is etched while the plastic substrate is not etched. As the mechanical strength of the plastic substrate required in the manufacture line is not so important, the plastic substrate may be made thin from the start.

If the glass substrate of the first substrate and the glass substrate of the second substrate have different initial thicknesses and the same etch rate, the total thickness of the two substrates is reduced and one of the substrates is made thinner than the other by immersing the two substrates in an etching solution for the same period of time.

### BRIEF DESCRIPTION OF THE DRAWINGS

FIG. 1 is a sectional view schematically illustrating a liquid crystal display device according to a first embodiment.

FIG. 2 is an enlarged sectional view illustrating glass substrates before etching.

FIG. 3 is an enlarged sectional view illustrating the glass substrates after etching.

FIG. 4 is a sectional view schematically illustrating a liquid crystal display device as a variant of the first embodiment.

FIG. 5 is a graph illustrating a relationship between glass substrate thickness and etch time.

FIG. 6 is a sectional view schematically illustrating a liquid crystal display device according to a second embodiment.

FIG. 7 is a sectional view schematically illustrating a liquid crystal display device according to a third embodiment before etching.

FIG. 8 is a sectional view schematically illustrating a liquid crystal display device according to another embodiment.

FIG. 9 is a sectional view schematically illustrating a conventional liquid crystal display device.

### DETAILED DESCRIPTION OF THE INVENTION

Hereinafter, a detailed explanation of the present invention will be provided by way of embodiments with reference to the drawings. It should be noted that the present invention is not limited to these embodiments.

### First Embodiment

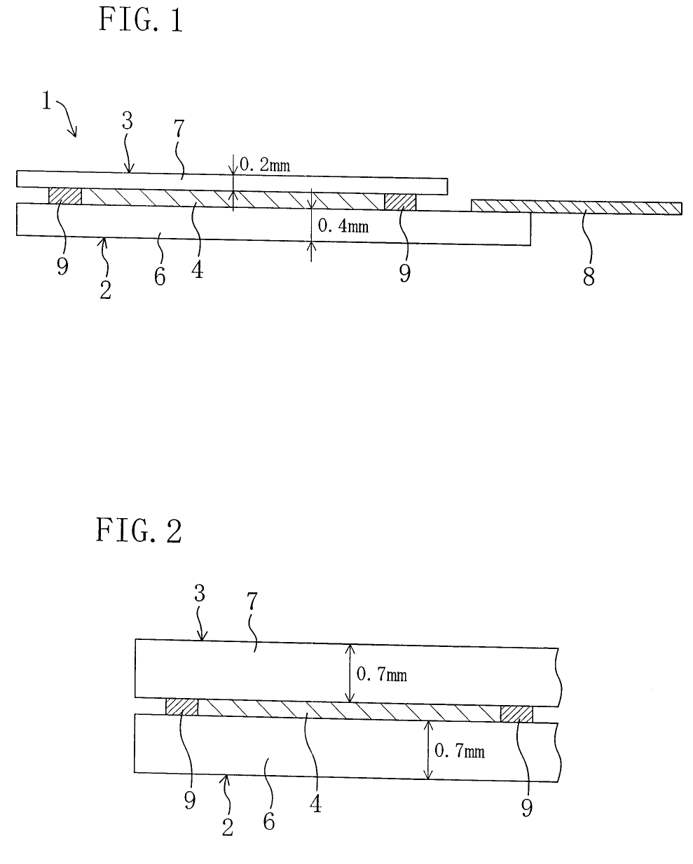

FIGS. 1 to 5 show a first embodiment of the present invention.

FIG. 1 is a sectional view schematically illustrating a liquid crystal display device 1 as a display device of the present invention. As shown in FIG. 1, the liquid crystal display device 1 includes an active matrix substrate 2 as a first substrate, a counter substrate 3 as a second substrate facing the active matrix substrate 2 and a liquid crystal layer 4 as a display medium layer provided between the substrates 2 and 3.

The active matrix substrate 2 includes a glass substrate 6 and a plurality of thin film transistors (not shown and abbreviated as TFTs) which are formed on the surface of the glass substrate 6 facing the liquid crystal layer 4. The active matrix substrate 2 further includes a plurality of pixels arranged in a matrix. The TFTs are provided on a pixel-by-pixel basis.

The thickness of the glass substrate 6 is 0.4 mm, for example. An orientation film (not shown) is formed on the surface of the glass substrate 6 facing the liquid crystal layer 4 to cover the TFTs. A polarizing plate (not shown) is stacked on the other surface of the glass substrate 6 not facing the liquid crystal layer 4.

A driver (not shown) for driving and controlling the TFTs is also formed on the glass substrate 6. The TFTs are connected to the driver through signal wires and scanning wires which are not shown in the drawings. The TFTs and the driver include semiconductor elements made of low-temperature polysilicon, for example.

As shown in FIG. 1, a flexible printed substrate 8 is mounted on the active matrix substrate 2. The flexible printed substrate 8 is connected to the driver and supplies a drive signal to the driver.

The counter substrate 3 includes a glass substrate 7. A color filter and shared electrodes made of ITO (not shown) are formed on the surface of the glass substrate 7 facing the liquid crystal layer 4. The thickness of the glass substrate 7 is 0.2 mm, for example, which is smaller than the thickness of the glass substrate 6 of the active matrix substrate 2. An orientation film (not shown) is formed on the surface of the glass substrate 7 facing the liquid crystal layer 4 to cover the color filter and the shared electrodes. A polarizing plate (not shown) is formed on the other surface of the glass substrate 7 not facing the liquid crystal layer 4.

The active matrix substrate 2 and the counter substrate 3 are bonded to each other with a spacer (not shown) and a sealing member 9 sandwiched therebetween. A certain gap is formed between the active matrix substrate 2 and the counter substrate 3, in which liquid crystal material is sealed to form the liquid crystal layer 4. Thus, the liquid crystal display device 1 is configured such that the driver and the TFTs control the orientation of the liquid crystal molecules in the liquid crystal layer 4 on the pixel-by-pixel basis, thereby producing a desired display.

As a characteristic of the present invention, the rate at which the glass substrate 6 of the active matrix substrate 2 is etched by an etching solution containing hydrogen fluoride is lower than the rate at which the glass substrate 7 of the counter substrate 3 is etched by the same etching solution. The glass substrate 6 is made thicker than the glass substrate 7 and therefore has higher mechanical strength than that of the glass substrate 7.

### Manufacturing Method

Next, an explanation of a method for manufacturing the liquid crystal display device 1 will be provided. The method includes the steps of bonding the substrates, etching the substrates and mounting the flexible printed substrate.

First, in the step of bonding the substrates, TFTs, pixel electrodes, signal wires, scanning wires and a driver, which are not shown in the drawings, are formed on a glass substrate 6 as a component of an active matrix substrate 2. The TFTs and the driver include elements made of low-temperature polysilicon.

On a glass substrate 7 as a component of a counter substrate 3, a color filter and shared electrodes which are not shown in the drawings are formed. An orientation film is then formed thereon to cover the color filter and the shared electrodes. The glass substrates 6 and 7 are bonded together with a spacer and a sealing member 9 sandwiched therebetween. Then, liquid crystal material is sealed in a gap formed between the glass substrates 6 and 7 to form a liquid crystal layer 4. Before etching, the glass substrates 6 and 7 have the same thickness of 0.7 mm as shown in FIG. 2. The reason why the initial thicknesses of the glass substrates 6 and 7 are set to 0.7 mm is that it is the usual thickness employed in the manufacture line and hence the substrates are easily handled.

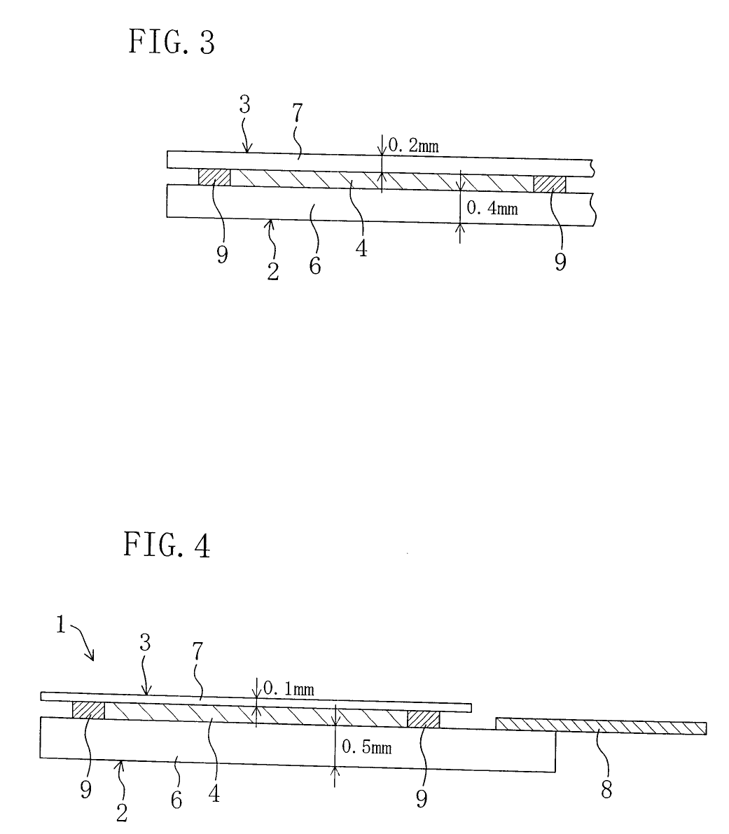

Next, in the step of etching the substrates, the bonded glass substrates 6 and 7 are immersed in an etching solution containing hydrogen fluoride. Specifically, the glass substrates 6 and 7 are etched for the same period of time. In this step, each of the glass substrates 6 and 7 is thinned down. The etch rates of the glass substrates 6 and 7 in the etching solution are varied such that the glass substrate 6 is etched more slowly than the glass substrate 7. Therefore, as shown in FIG. 3, the glass substrate 6 is etched by a smaller amount to reduce the thickness to 0.4 mm, while the glass substrate 7 is etched by a larger amount to reduce the thickness to 0.2 mm. As a result, the mechanical strength of the glass substrate 6 becomes higher than that of the glass substrate 7. Then, polarizing plates are deposited on the outside surfaces of the glass substrates 6 and 7, respectively.

Next, in the step of mounting the flexible printed substrate, a flexible printed substrate 8 is mounted on the active matrix substrate 2 including the etched glass substrate 6. Thus, through the above-described steps, the liquid crystal display device 1 is fabricated.

### Effect of the First Embodiment

The flexible printed substrate 8 is press-mounted on the active matrix substrate 2. Therefore, the active matrix substrate 2 needs to have enough mechanical strength to endure the pressure applied thereto in the mounting step. The counter substrate 3 does not require such a mechanical strength. According to the present embodiment, even if the initial thicknesses of the glass substrates 6 and 7 before etching are the same, the active matrix substrate 2 which requires certain mechanical strength is made relatively thick, while the counter substrate 3 which does not require such a mechanical strength is made relatively thin by etching. Therefore, the total thickness of the active matrix substrate 2 and the counter substrate 3 are reduced. As a result, the liquid crystal display device 1 is slimmed down. Since the glass substrates 6 and 7 have the same thickness before etching, the substrates are easily handled in the manufacture line and can be worked with existing manufacturing facilities.

Moreover, as the slimming down of the resulting device is achieved by single immersion of the glass substrates 6 and 7 in the etching solution, the manufacturing steps are simplified. Therefore, reduction in production cost and improvement in yield are expected.

If amorphous silicon is used to form the TFTs and the driver, the driver must be mounted on the flexible printed substrate 8. As a result, the flexible printed substrate 8 including the driver inevitably becomes thick. Therefore, even if the glass substrates 6 and 7 are thinned down, the thickness of the device cannot be easily reduced due to the thick flexible printed substrate 8. In the present embodiment, however, low-temperature polysilicon is used to form the TFTs and the driver. Therefore, the driver is formed on the glass substrate 6 without significant increase in substrate thickness and the resulting device is effectively slimmed down.

As shown in FIG. 4, the thickness of the glass substrate 6 of the active matrix substrate 2 may be set to 0.5 mm and the thickness of the glass substrate 7 of the counter substrate 3 may be set to 0.1 mm. With these thicknesses, the thickness of the resulting device is kept about 0.6 mm and the mechanical strength of the glass substrate 6 is enhanced.

If it is difficult to control the final thicknesses of the glass substrates 6 and 7 by merely adjusting the etch rates, the thicknesses of the glass substrates 6 and 7 may be adjusted before etching.

### EXAMPLE

Now, an explanation of a specific example of the present invention will be provided.

A glass substrate A (AN100 manufactured by ASAHI GLASS) was used as the glass substrate 6 of the active matrix substrate 2 and a glass substrate B (1737 manufactured by Corning) was used as the glass substrate 7 of the counter substrate 3. Under certain etching conditions, the etch rate of the glass substrate A is 4.4 μm/min and that of the glass substrate B is 5.2 μm/min.

Elements such as TFTs and wires were formed on the glass substrate A and a color filter and other elements were formed on the glass substrate B. Then, the glass substrates A and B are bonded together. The bonded substrates were immersed in an etching solution containing hydrogen fluoride under the above-described conditions to etch the substrates for about 42 minutes. As shown in Table 1, the thicknesses of the glass substrates A and B after the 42-minute etching were 0.52 mm and 0.48 mm, respectively.

TABLE 1

| | Time (minute) | | |
|---|---|---|---|
| | 0 | 42 | 84 |
| Thickness of glass | 0.7 | 0.52 | 0.34 |
| substrate A (mm) | | | |
| Thickness of glass | 0.7 | 0.48 | 0.26 |
| substrate B (mm) | | | |
| Total thickness | 1.4 | 1.00 | 0.6 |
| (mm) | | | |

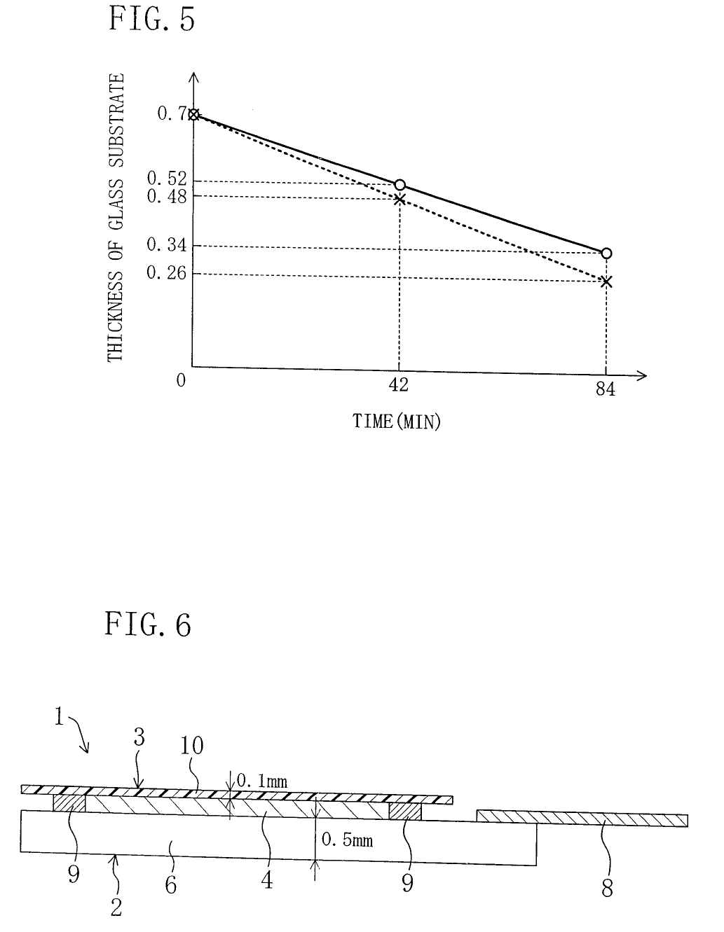

The etching was continued for another 42 minutes. Then, as shown in Table 1, the thickness of the glass substrate A was reduced to 0.34 mm and that of the glass substrate B was reduced to 0.26 mm. FIG. 5 shows a graph illustrating the variations in thicknesses of the glass substrates A and B. FIG. 5 indicates that the thicknesses of the glass substrates A and B are linearly reduced with time. From the obtained results, it is found that if each of the glass substrates A and B has an initial thickness of 1.1 mm and the etching is carried out for 166 minutes, the thicknesses of the glass substrates A and B are reduced to 0.37 mm and 0.23 mm, respectively, thereby obtaining a desired device having a thickness of about 0.6 mm.

### Second Embodiment

FIG. 6 shows a second embodiment of the present invention. In the following embodiments, the same components as those shown in FIGS. 1 to 4 are indicated by the same reference numerals to omit a detailed explanation.

A liquid crystal display device 1 of the present embodiment includes an active matrix substrate 2, a counter substrate 3 and a liquid crystal layer 4 as shown in FIG. 6. The active matrix substrate 2 includes a 0.5 mm thick glass substrate 6. The counter substrate 3 includes a 0.1 mm thick plastic substrate 10. In other words, the liquid crystal display device 1 includes the glass substrate 6 and the plastic substrate 10 which is provided to face the glass substrate 6 and thinner than the glass substrate 6.

In order to fabricate the liquid crystal display device 1 described above, first, in the step of bonding the substrates, a color filter (a coloring layer), TFTs, pixel electrodes, signal wires, scanning wires and a driver which are not shown in the drawings are formed on the glass substrate 6 as a component of the active matrix substrate 2. Then, an orientation film is formed thereon. The TFTs and the driver include elements made of low-temperature polysilicon. The thickness of the glass substrate 6 before etching is 0.7 mm, for example.

Shared electrodes and other elements which are not shown in the drawings are formed on the plastic substrate 10 as a component of the counter substrate 3. The thickness of the plastic substrate 10 is 0.1 mm, for example. Then, the glass substrate 6 and the plastic substrate 10 are bonded together and a liquid crystal layer 4 is formed therebetween in the same manner as described in the first embodiment.

In this embodiment, the color filter is formed not on the counter substrate 3 but on the active matrix substrate 2. Therefore, the liquid crystal display device 1 is achieved with accuracy irrespective of different thermal expansion coefficients of glass and plastic.

Then, in the step of etching the substrates, the glass substrate 6 and the plastic substrate 10 bonded to each other are immersed in an etching solution containing hydrogen fluoride. At this time, only the glass substrate 6 is etched, but the plastic substrate 10 is not etched. As a result, the thickness of the glass substrate 6 is reduced to 0.5 mm, for example. The glass substrate 6 is kept thicker than the plastic substrate 10. The subsequent steps are the same as those described in the first embodiment. Thus, the liquid crystal display device 1 is fabricated.

### Effect of the Second Embodiment

According to the second embodiment, the glass substrate 6 and the plastic substrate 10 are used as a pair of substrates. Therefore, only the glass substrate 6 is etched, while the plastic substrate 10 is not etched. As the mechanical strength of the plastic substrate 10 required in the manufacture line is not so important, the plastic substrate 10 may be made thin from the start. Therefore, the liquid crystal display device 1 is easily slimmed down.

### Third Embodiment

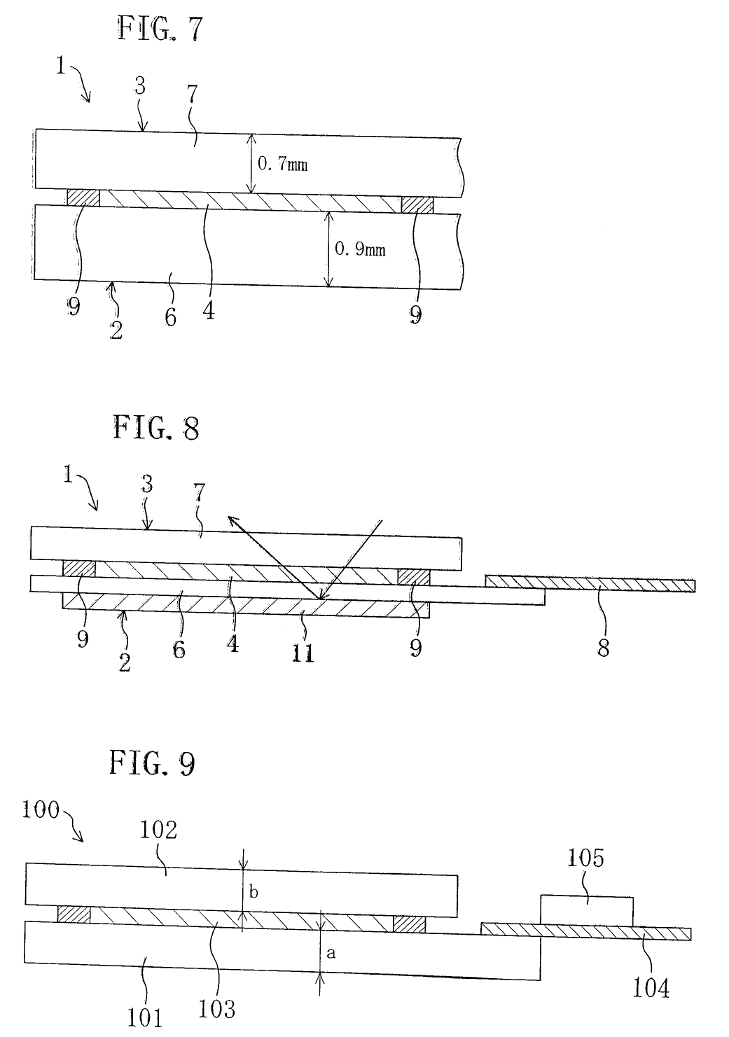

FIG. 7 shows a third embodiment of the present invention.

In the present embodiment, the rate at which a glass substrate 6 of an active matrix substrate 2 etched by an etching solution is the same as the rate at which a glass substrate 7 of a counter substrate 3 etched by the same etching solution. Specifically, the glass substrates 6 and 7 are made of the same glass material.

The thicknesses of the glass substrates 6 and 7 before etching are 0.9 mm and 0.7 mm, respectively. In the step of bonding the substrates, the glass substrates 6 and 7 are bonded together and a liquid crystal layer 4 is formed therebetween. In the following etching step, the bonded substrates 6 and 7 are immersed in an etching solution containing hydrogen fluoride. As a result, the glass substrates 6 and 7 are thinned down by 0.5 mm, respectively. Specifically, the thickness of the glass substrate 6 is reduced to 0.4 mm and the thickness of the glass substrate 7 is reduced to 0.2 mm.

As described above, the glass substrates 6 and 7 having different thicknesses before etching are etched at the same etch rate. Also in this method, the glass substrate 6 is made thicker than the glass substrate 7. However, in the general manufacture line, the thicknesses of the glass substrate 6 and 7 before etching are preferably the same in view of ease of handling.

### Other Embodiments

In the above-described embodiments, the TFTs and the driver include elements made of low-temperature polysilicon. However, the TFTs and the driver may include elements made of CG silicon. In this case, as the driver may be formed on the glass substrate 6 together with the TFTs. Therefore, the display device is expected to be slimmed down. The driver may be formed in the step of bonding the substrates in the same manner as the foregoing embodiments using low-temperature polysilicon.

A structure as shown in FIG. 8 is also available. Specifically, in a reflective liquid crystal display device, it is advantageous to provide a reflective layer 11 on the outside surface of the glass substrate 6 from the viewpoint of cost. However, as indicated by an arrow in FIG. 8, light incident on the glass substrate 6 is reflected by the reflective layer 11 and then passes through the glass substrate 6 again, thereby increasing parallax. In this respect, the glass substrate 6 is preferably thin. If the glass substrate 7 is also thinned down, the strength of the device decreases. Therefore, the glass substrate 7 is preferably thicker than the glass substrate 6.

As a possible solution, the glass substrates are configured to have different etch rates and the same initial thickness before etching. By so doing, the glass substrate 6 is made relatively thin and the glass substrate 7 is made relatively thick with ease.

In the above-described embodiments, the first substrate 2 includes the glass substrate 6 and the second substrate 3 includes the glass substrate 7 or the plastic substrate 10. However, the present invention is not limited to these embodiments. The first and second substrates 2 and 3 may be semiconductor substrates such as silicon wafer.

Thus, as described above, the present invention is useful for a display device and a method for manufacturing the display device. In particular, the present invention is suitable for the slimming down of the display device through simple manufacturing steps with reduction in manufacturing cost and improvement in yield.

What is claimed is:

1. A method for manufacturing a display device comprising the steps of:
bonding a glass substrate and a plastic substrate and forming a display medium layer between the glass substrate and the plastic substrate; and
immersing the glass substrate and the plastic substrate bonded to each other in an etching solution such that only the glass substrate is thinned down.

2. The method of claim 1, wherein
the etched glass substrate is thicker than the plastic substrate.

3. The method of claim 1, wherein
the display medium layer is a liquid crystal layer.
